(19) United States
(12) Patent Application Publication
(10) Pub. No.: US 2013/0209730 A1
(43) Pub. Date: Aug. 15, 2013

(54) PROCESS AND APPARATUS FOR PRODUCING A MULTILAYERED PANEL OF MATERIAL FOR SUBDIVISION INTO BEAM-SHAPED PRODUCTS AND A PANEL OF MATERIAL

(71) Applicants: Lee Barker, Hawthorn East (AU); Gernot Von Haas, Heidelberg (DE)

(72) Inventors: Lee Barker, Hawthorn East (AU); Gernot Von Haas, Heidelberg (DE)

(73) Assignee: DIEFFENBACHER GMBH MASCHINEN-UND ANLAGENBAU

(21) Appl. No.: 13/699,267

(22) PCT Filed: May 30, 2011
(86) PCT No.: PCT/EP11/58868

§ 371 Date: Jan. 30, 2013

(30) Foreign Application Priority Data
May 30, 2010 (DE) 10 2010 029 486.1

(51) Int. Cl. B32B 37/14; B32B 5/16

(52) U.S. Cl. CPC B32B 37/14; B32B 5/16
USPC 428/107; 156/199; 156/510

(57) ABSTRACT

A process and apparatus for producing a multilayered panel of material. In a first step an oriented single-layered mat is formed in a forming station from resinated particulate longitudinally orientable in machine direction, the single-layered mat is compressed in a continuous working press to form an oriented single-layered panel strand, the single-layered panel strand is subdivided at least once by a subdividing device into oriented single-layered panels, wherein a layered pack comprising three layers at least, or a layered pack strand comprising of three layers at least, is formed in a laying device and single-layered panels are used in two layers at least. The layered pack or the layered pack strand is compressed in a cyclically or continuously working press into a panel of material or into a material panel strand dividable by a dividing device into a panel of material and the panel of material is subdivided into beam-like products, more particularly artificially produced board layer woods, of greater height than width.

The invention relates to a method for producing a multilayered material panel according to the preamble of claim 1. Furthermore, the invention relates to a material panel according to claim 13 and to a facility for producing a multilayered material panel according to claim 17.

To produce wooden composite panels, discontinuous multi-daylight presses and continuously operating presses are typically used, in the latter, a scattered compressed material mat having glue-coated scattered particles being compressed under pressure and introduction of heat between two revolving steel belts. In addition to solely particulate panels (MDF), machined wood scraps are also used, which are typically scattered in an oriented manner, to provide the produced wooden composite panels with reinforced strength in length and width. Types of production are differentiated for oriented scattered panels in the longitudinal and transverse directions (OSB) and an orientation solely in the longitudinal direction (OSL). Such OSB and OSL panels are typically produced on continuous double-belt presses.

A continuous method for producing wooden composite panels is known from DE 10 2005 035 214 A1, in which a compressed material mat is formed in a scattering station on a continuously moving forming belt, which mat consists of one or more layers of oblong wood scraps scattered oriented longitudinally to the production direction or scattered oriented longitudinally and transversely, and which, after introduction between the steel belts, which revolve around upper and lower frame parts, of a continuously operating press, is cured under the application of pressure and heat to form an endless wooden composite panel. The method has fundamentally proven itself.

In the meantime, the demand of the container industry for inexpensive but sufficiently strong and stable floor plates for shipping, storage, office, or living containers has proven to be of wide-ranging economic significance. A specification of the industry for container panels prescribes a bending strength of 69 N/mm² at a support spacing of 250 mm for 28 mm thick container floors. Other specifications prescribe higher support spacings in the comparison for testing the bending strength, which also result in higher bending strains. The smaller support spacing of 250 mm results in very high shear stresses in the neutral fibers of the panel during the bending test, however. Therefore, up to this point predominantly plywood panels having densities around 900 kg/m³ have been used as the panels for container floors. In addition to the high bending strength, the panel surface must have a sufficient hardness and adequate abrasion resistance. In addition, the load which is applied by means of a wheel, for example, of a forklift, to the panel must be sufficiently distributed in the panel longitudinally and transversely to the wheel via the supports of the sheet-metal grooves on the container floor.

The main problem is that the transverse scattering is problematic in relation to the longitudinal scattering in the production of oriented scattered layers. Continuous transverse scattering suffers from many flaws and additionally requires massive trimming after the scattering, because the edge regions of the scattered mat made of chips or scraps are typically coated significantly less. However, even after massive trimming, the produced multilayer panels have problems in the transversely scattered layers of the panel.

Because of these high requirements, up to this point it has not been possible to produce a panel from scraps which meets the high requirements of industrial container construction. On the other hand, a replacement for plywood panels is urgently sought after, since the required veneers for a plywood panel are costly and, in addition, impregnation of the veneers with fungicides (agents which prevent fungal growth) is difficult. Since a high percentage of containers is shipped worldwide on container ships, many of these container panels are subject to a high ambient humidity in poorly ventilated spaces, which also requires a regular replacement of the container panels. A container plate which was already resistant or could offer a higher level of resistance against mold and fungus infestation in the course of production would be very advantageous here.

The invention is based on the object of providing a method and a facility, using which it is possible to produce multilayered material panels for producing multilayered beam-like products simply and cost-effectively. Furthermore, an oriented scattered material panel is to be provided, which can be used as a more cost-effective alternative or as a competing product in relation to the plywood panels with comparable properties. In particular, the beam-like products are to be used as artificially produced laminated timbers or can be used thereafter for the use as still taller artificially produced laminated timbers.

The object of the method is achieved in that a single-layer oriented scattered layer mat is formed from glue-coated scattered material, which can be oriented longitudinally in the production direction, in a forming station, the layer mat is compressed in a continuously operating press to form a single-layer oriented layer panel strand, the layer panel strand is divided at least once by means of a dividing device to form single-layer oriented layer panels, a layer packet consisting of at least three layers or a layer packet strand consisting of at least three layers is formed in a laying device, layer panels being used in at least two layers, and the layer packet or the layer packet strand is compressed in a cyclically or continuously operating press to form a material panel or a material panel strand, which can be divided to form a material panel, and the material panel is divided into beam-like products, in particular artificially produced laminated timbers, of greater height than width.

The achievement of the object for a material panel is that the material panel comprises at least three layers which are glued together, at least two layers consisting of a single-layer oriented layer panel.

The object for a facility is achieved in that the facility comprises at least one laying device for producing a layer packet or a layer packet strand from at least three layers, layer panels being used in at least two layers, and a cyclically operating press for compressing the layer packet or the layer packet strand to form a material panel or a continuously operating press for compressing the layer packet or the layer packet strand to form a material panel strand and a dividing device for dividing the material panel strand into material panels.

The facility can advantageously also have a forming station for producing a single-layer oriented scattered layer mat from a scattered material which can be oriented, a continuously operating press for compressing the layer mat to form a single-layer oriented layer panel strand, and a following dividing device for dividing the layer panel strand into a single-layer oriented layer panel.

In addition, a storage and/or transfer device can also be arranged between the individual facility parts, in particular between the dividing device and the laying device.

The single-layer oriented scattered production of an oriented scattered chip panel (OSB) in a single-layer or multilayer embodiment has already been prior art for some time. The invention advantageously makes use of the circumstance that the longitudinal scattering (orienting of the scraps in the longitudinal direction, i.e., parallel to the production direction) can be carried out almost perfectly in the meantime. Thus, single-layer longitudinally oriented layer panels are produced, which have a nearly optimum scattering value (deviation of the angle in the longitudinal direction of the scattered material, which can be oriented, from the specification) through the longitudinal scattering. These layer panels are divided accordingly after the compression, in particular in the case of the continuous production, a longitudinal and/or transverse division can be performed after the continuously operating press, laid together to form a layer packet, and finally glued together to form a multilayer material panel.

Layer panels of a panel thickness of 6 mm are particularly preferably produced, which are subsequently glued together and compressed in five layers to form a material panel having approximately 30 mm thickness. With corresponding grinding down of the surfaces before the gluing, a material panel thickness of the final product of 28 mm results in the typical process, which is ideal for container flooring (laying the floor of a container).

In a partial aspect of the invention, a use of the material panel as a load-bearing covering, in particular as a floor covering on support surfaces, which extend in parallel and are spaced apart, while utilizing its special properties or preferred direction, is to be provided. For this purpose, the material panel, consisting of at least five layers, is arranged having the predominant number of layer panels oriented in the same direction transversely to a possible support structure or support surfaces, to bridge structure-related gaps, for example, as are present in containers on the floor due to the sheet-metal trapezoidal or U-profile frame structure.

The invention understands an adhesive or binder for the glue coating of the planar sides or the scattered material as a so-called adhesive solder, which consists in its main components of an adhesive. As needed, additional emulsion, curing agent, formaldehyde scavenger, colorants, insect protection agents and fungus protection agents and other additives are added. It is also typical to use the adhesive without additives. MDI (diphenylmethane diisocyanate) or PMDI (polymer diphenylmethane diisocyanate) from the group of isocyanates is preferably used as the adhesive. The proposed material panel (five-layer panel) or the use thereof can result, on the one hand, through the method according to the invention; however, it can also be considered to be an independent material panel.

Furthermore, the invention understands a layer mat as a compressed material mat, which is compressed in a press to form a layer panel, in the present case in particular the layer mats having an oriented scattering of the scattered material in the production direction (longitudinal direction) being meant. A layer panel which uses the material panel at least partially, preferably for all layers, thus consists of an oriented scattered layer panel. A single-layer scattered layer panel is understood in the invention as an oriented scattered layer mat in the longitudinal direction of the production direction, i.e., parallel to the production direction, which when compressed results in a single-layer layer panel, which consists of chips or scraps oriented in one direction. These layer panels may finally be laid together to form a layer packet, at least one touching side between the layers being glue coated except for the outer or cover surfaces. The surfaces of the layer panels to be glue coated are preferably ground down, on the one hand, to decrease the adhesive consumption, on the other hand, to avoid irregularities, which could result in separation of the individual layers during use. Of course, instead of a layer packet, a layer packet strand can also be formed, the butt joints between the layer panels of one layer lying one on top of another not being located at the same point as those of the adjacent layers here. Alternatively, the introduction of complete layer packets abutted or spaced apart from one another in a continuously operating press would also be conceivable. In this case, the resulting material panel strand must be divided once again, before the material panels may result. In the case of the formation of the layer packet or the layer packet strand from at least two single-layer oriented layer panels, at least one layer panel is to be laid in a different orientation than a further single-layer oriented layer panel. Of course, it can also be advisable if it does not form the middle layer in the case of an odd number of layers, for example, so that they have the same orientation in the material panel. Therefore, each layer panel can be laid on the next layer panel having a preferably perpendicular difference of the orientation to one another in the laying device. In particular, it is advantageous if a layer panel strand is divided transversely to the production direction to form square layer panels, since they may be stacked best without much clipping or cutting to size.

The layer panel strand can accordingly be divided longitudinally and subsequently transversely to the production direction to form square layer panels. Layer panels still having residual heat from the compression in the press can be laid together to form a layer packet or a layer packet strand. During the method, the layer panels and/or the layer panel strand are to be treated on at least one planar side. The glue coating of the planar sides of the layer panels is performed before the preparation of the layer packet or in the laying device on the layer packet which is not yet finished. During the preparation of a layer packet or a layer packet strand, the butt joints between two layer panels of a layer are to diverge from the butt joints of adjacent layers. At least in the case of two single-layer oriented layer panels, when the layer panels are laid on one another, a different orientation to one another is to be used. The scattered material is preferably a material containing lignocellulose or preferably has a thickness of 0.6 to 1.1 mm and/or a width of 5 to 90 mm. The length can be from 40 to 300 mm. A plastic, a metal, a film, and/or cork can be used to form at least one alternative layer of the layer packet or the layer packet strand. The layer panel can or the layer panels are also ground on one or both sides before the glue coating, so that the thickness is implemented uniformly over the length and width. No flaws are present in the glue joint due to the grinding.

A layer packet consisting of five, seven, or nine layers or a layer packet strand consisting of five, seven, or nine layers is particularly preferably formed. In particular, a layer packet consisting of five, seven, or nine layers or a layer packet strand consisting of five, seven, or nine layers is to be formed in particular, each layer consisting in this case of oriented layer panels. The layer located in the middle preferably has a different thickness than the external layers. The layers to be laid at the same distance to the middle layer are also to have equal thicknesses, in order to ensure a uniform construction with an odd number of layers. A material panel accordingly comprises at least three layers which are glued together, at least two layers consisting of a single-layer oriented layer panel. The layer panels of different layers are to diverge in their orientation, in particular at a 90° angle to one another.

In a specially designed and implemented method and facility application, a layer panel strand produced in a continuously operating press is divided once longitudinally and then transversely or, vice versa, first transversely and then longitudinally. Therefore, two adjacent layer panel rows result on a production line, which can simply be laid one on top of the other in a laying device, in a corresponding sequence, the layer panels being rotated by 90° to produce the layer packet or a layer packet strand, which is in turn compressed. Upon a longitudinal cut and the following transverse division, the possibility advantageously results of also arranging a cyclic press after a continuously operating press, since multiple layer panels, preferably 5 or 7, are laid one on top of another by the laying device and a compression of a layer packet can be carried out during the laying procedure to form a layer packet.

The relevant laying devices are sufficiently known from veneer laying technology. A preferably producible material panel according to the invention thus has at least three, particularly preferably five or seven layers made of individual panels, the individual panels consisting of single-layer oriented layer panels.

In addition to the production of such material panels, the production of very thick (beam-like) material panels, in particular artificially produced laminated timber, would also be conceivable. Laminated timber (BSH) is also known as glued laminated timber or colloquially referred to as glued wood. Wooden boards are dried, planed, and connected to form lamellae, mostly by means of finger joints, and glued together (cold) in multiple layers. In particular in large halls or elongated bridges, glued wood can compete with other materials, in particular steel construction, and is distinguished by a more attractive appearance, lower weight, and significantly longer lifetime in case of fire. It is now proposed that (beam-like) material panels also be manufactured by means of the present method and facility, which can compete with these products (glued woods). For example, single-layer oriented layer panels which are 30 mm or even up to 65 mm thick could be produced from the initially produced layer panels, for example. On the upper end, with respect to the thicknesses, technological limits currently only exist with respect to the through heating of the layer mat, since with very tall layer mats and their compression, the continuously operating press becomes longer and longer as a result of the compression factor. For example, if 30 mm layer panels are laid together to form a five-layered layer panel strand or a layer packet, material panels can be produced therefrom, which are 150 mm thick. If these are divided (relatively narrow) as material panels which are 2.5 m wide and 20 m long after a compression which is preferably carried out cyclically, a rather beam-like product results from the produced material panel.

To produce such a material panel, under certain circumstances, certain precautions would be taken and especially cold-curing glue would be used as the binder or even solely compression would be carried out. It would even be conceivable to heat up the glue by means of high-frequency radiation, in particular microwaves. A cyclically or continuously operating press used in the second step (according to 1.5) would not necessarily have to be a hot press.

The transition from material panels is thus rather flowing, one could designate panel thicknesses from 100 mm already as “beams”, of course, but which are first cut out of the planar panels in the course of the division in the present application in the case of a planar compression.

In particular with such highly complex material panel applications, it is necessary to prepare the surfaces before the glue coating accordingly. Very level surfaces are required in this case, which are typically made possible by a grinding procedure, so that optimum glue coating or glue bonding can be produced, respectively.

With respect to the chips, the invention understands these as chips, scraps, flakes, or the like which can be oriented, and which are suitable for the purpose during the scattering of being scattered in an oriented manner to form a layer mat. A single-layer oriented scattered layer mat is understood as a layer mat made of material which can be oriented, which has predominantly been scattered oriented and compressed, and therefore, in particular in a sectional view, has an unambiguous orientation of a predominant fraction of the scattered material. For high-strength applications, in particular to produce artificial glued wood made of artificially produced individual layer panels, which have been glued together and compressed in multiple layers, eucalyptus and/or hardwoods can achieve particularly good results. The beam-like products are then laid one on top of another thereafter and glued together to produce taller artificially produced laminated timbers.

Further advantageous measures and embodiments of the subject matter of the invention are provided in the subclaims and the following description with the drawing.

In the figures:

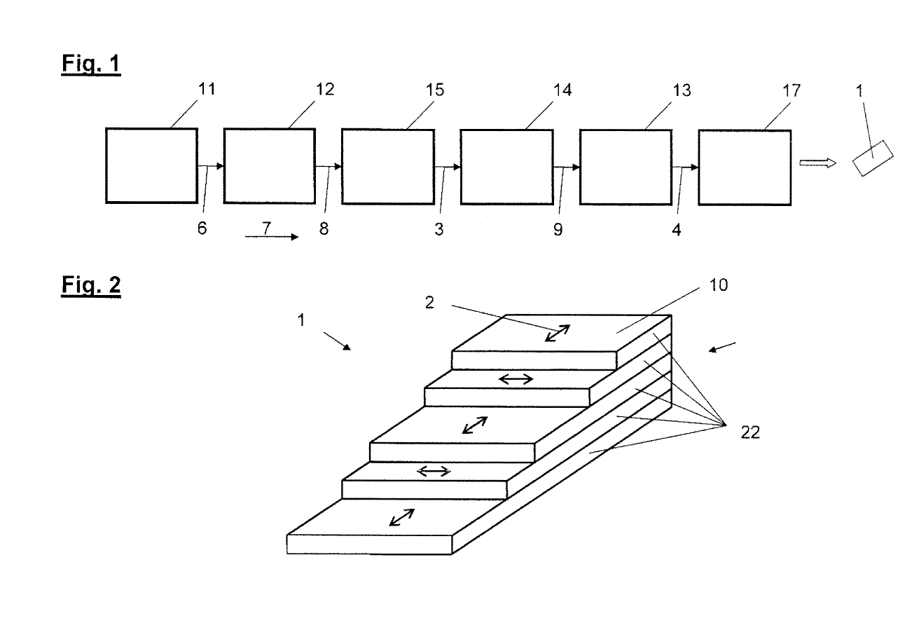

FIG. 1 shows the schematically illustrated production sequence of a production of a material panel from a layer packet, which is prepared from multiple layer panels, with subsequent compression,

FIG. 2 shows a three-dimensional sectional view of a material panel made of five layer panels, which are laid on one another and glued together,

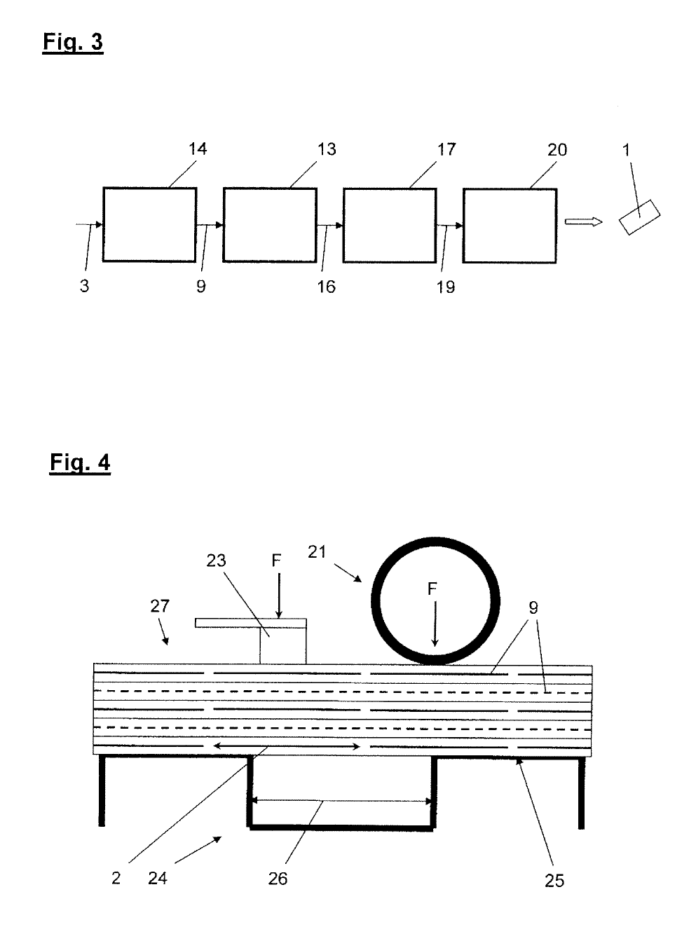

FIG. 3 shows a variant of the production sequence of a production of a material panel from a layer packet strand, which is prepared from multiple layer panels, and which is compressed in a continuously operating press and subsequently divided to form a material panel,

FIG. 4 shows a schematic view of a material panel as a covering on a support structure with exemplary load by a pallet base and a wheel of a forklift or a pallet lift truck, respectively.

FIG. 1 shows a schematic and exemplary production sequence for the production of a material panel from wood or wood-like raw materials. In a preparation 11, scattered material 6 is prepared and glue coated from the raw materials. The glue-coated scattered material 6 is subsequently scattered in a forming station 12, in the parallel direction to the production direction 7 and on a continuous endless revolving forming belt (not shown) to form a single-layer layer mat 8 oriented in the production direction 7. The layer mat 8 can be subjected to a pretreatment (not shown) before the compression, which comprises a change of the temperature, the moisture, and/or the density of the layer mat. Subsequently, the layer mat 8 is compressed using a continuously operating press 15 to form a layer panel strand 3 and subsequently divided using a dividing device 14 to form layer panels 9. Directly (still having the residual heat from the compression) or indirectly (after unloading, production location change, or the like) after the compression, a layer packet 4 is formed in a laying device 13. Before or in the laying device, the planar sides 10, which later lie adjacent to a further layer panel 9, can be glue coated. The compression of the layer packet 4 is performed in a press 17, which can be implemented as cyclically or preferably continuously operating. It would also be conceivable in the case of a low workload of the facility to carry out the compression to form a material panel in the first press 15. It is also conceivable to introduce the formed layer packets continuously having no or little spacing into a continuously operating press and to carry out the second compression continuously.

This is illustrated in a variant of the production sequence according to FIG. 3. The method is executed identically as in FIG. 1 until, instead of a layer packet 4 made of multiple layer panels 9 in the laying device 13, a layer packet strand 16 is prepared and this strand is compressed in a continuously operating press 17 to form a material panel strand 19 and subsequently divided to form a material panel 1 by means of a further dividing device 20.

FIG. 2 shows a five-layered material panel 1 having five layers 22 of different orientation 2 of the layer panels 9. The orientation 2 of a layer panel 9 preferably has a rotation of 90° to the adjacent layer panel in the material panel 1.

According to FIG. 4, in particular the use of the material panel 1 produced according to the method as the load-bearing covering 27 on a support structure 24 consisting of multiple support surfaces 25 separated by spacings 26 is preferred, the covering 27, consisting of one or more material panels 1, being arranged on the support structure 24 such that the majority of the layers 22 of the material panel 1, consisting of the oriented layer panels 9, are arranged transversely to the extension of the support surfaces 25. I.e., the two external and the middle layer panels 9 of a five-layered panel are arranged so that they are aligned parallel to the indicated support spacing 26.

Layer panels 9 are particularly preferably laid together oriented successively longitudinally, transversely, longitudinally, transversely, longitudinally to the production direction 7 to form a layer packet 4 or a layer packet strand 16, the layer panels 9 preferably being arranged substantially at right angles to one another. To illustrate the load situation, a wheel 23 of a forklift or a pallet lift truck is arranged on the covering 27 in FIG. 4. A pallet base 23 is located adjacent thereto as a detail. In both load situations, a force arrow F is shown in simplified form perpendicular to the planar side of the covering 27.

The facility is suitable overall for carrying out the method, but can also be operated independently. The material panel can in particular be produced according to the known method and/or on such a facility. (1412)

In summary, it is to be noted that if beam-like final products are to be produced, they do not yet have to be implemented as beam-like (taller than wide) in step 1.6, if they are to be used once again for the layered construction. The invention also understands beam-like as material panels/beam-like products which consist in height of multiple layers 22.

### LIST OF REFERENCE NUMERALS

1 material panel
2 orientation
3 layer panel strand
4 layer packet
5
6 scattered material
7 production direction
8 layer mat
9 layer panel
10 planar side
11 preparation
12 forming station
13 laying device
14 dividing device
15 continuously operating press
16 layer packet strand
17 press (cyclic/continuous)
18
19 material panel strand
20 dividing device
21 wheel of forklift/pallet lift truck
22 layer
23 pallet base
24 support structure
25 support surface
26 spacing
27 covering

1. A method for producing a multilayered material panel, wherein
1.1 a single-layer oriented scattered layer mat, made of glue-coated scattered material, which can be oriented longitudinally in the production direction, is formed in a forming station,
1.2 the layer mat is compressed in a continuously operating press to form a single-layer oriented layer panel strand,
1.3 the layer panel strand is divided at least once by means of a dividing device to form single-layer oriented layer panels,
1.4 a layer packet consisting of at least three layers or a layer packet strand consisting of at least three layers is formed in a laying device, layer panels being used in at least two layers,
1.5 the layer packet or the layer packet strand is compressed in a cyclically or continuously operating press to form a material panel or a material panel strand, which can be divided by means of a dividing device to form a material panel, and
1.6 the material panel is divided to form beam-like products, in particular artificially produced laminated timbers, of greater height than width.

2. The method according to claim 1, wherein the beam-like products are then again laid one on another and glued together to produce taller artificially produced laminated timbers.

3. The method according to claim 1, wherein the layer panels are ground on one or both sides before the glue coating.

4. The method according to claim 1, wherein the glue coating on at least one side of the planar sides of the layer panels is carried out before preparation of the layer packet or in the laying device on the not yet finished layer packet.

5. The method according to claim 1, wherein, in the laying device, each layer panel is laid on the next layer panel with identical orientation to one another.

6. The method according to claim 1, wherein, in the laying device, each layer panel is laid on the next layer panel with a perpendicular difference of the orientation to one another.

7. The method according to claim 1, wherein the layer panel strand is divided transversely to the production direction to form square layer plates and in particular is also divided longitudinally, preferably before the transverse division.

8. The method according to claim 1, wherein, during preparation of a layer packet or a layer packet strand, butt joints between two layer panels of one layer diverge from the butt joints of adjacent layers.

9. The method according to claim 1, wherein butt joints between two layer panels of one layer are connected by finger joints.

10. The method according to claim 1, wherein the scattered material has a thickness of 0.6 to 1.1 mm and/or a width of 5 to 90 mm and a length of 50 mm to 300 mm.

11. The method according to claim 1, wherein a layer packet consisting of five, seven, or nine layers or a layer packet strand consisting of five, seven, or nine layers is formed, each layer consisting of layer panels.

12. The method according to claim 1, wherein beam-like material panels of greater height than width are cut out of the material panel in the course of the division.

13. A material panel, comprising at least three layers glued together, wherein each of said at least three layers comprises a single-layer oriented layer panel.

14. The material panel according to claim 13, wherein the layer panels of different layers diverge in their orientation, in particular are arranged at a 90° angle to one another.

15. The material panel according to claim 13, wherein the material panel comprises five, seven, or nine layers, each layer comprising one layer panel and in particular existing butt joints of the layers being connected by finger joints.

16. The material panel according to claim 13, characterized by beam-like material panels of greater height than width, which result in the course of the division.

17. A facility for producing a material panel comprising at least one laying device for producing a layer packet or a layer packet strand made of at least three layers, layer panels being used in at least two layers, and a cyclically operating press for compressing the layer packet or the layer packet strand to form a material panel or a continuously operating press for compressing the layer packet or the layer packet strand to form a material panel strand and a dividing device for dividing the material panel strand into material panels.

18. The facility according to claim 17, also comprising a forming station for producing a single-layer oriented scattered layer mat made of glue-coated scattered material, which can be longitudinally oriented in the production direction, a continuously operating press for compressing the layer mat to form a single-layer oriented layer panel strand, and a following dividing device for dividing the layer panel strand into a single-layer oriented layer panel.

19. The facility according to claim 17, also comprising a storage or transfer device between the individual facility parts, in particular between the dividing device and the laying device.

20. The facility according to claim 17, wherein a device for producing finger joints on the layer panels is arranged.
